(19) United States
(12) Patent Application Publication
(10) Pub. No.: US 2013/0135536 A1
(43) Pub. Date: May 30, 2013

(54) ILLUMINATING DEVICE, DISPLAY DEVICE AND TELEVISION RECEIVING DEVICE

(71) Applicant: Yasumori Kuromizu, Osaka-shi (JP)

(72) Inventor: Yasumori Kuromizu, Osaka-shi (JP)

(73) Assignee: Sharp Kabushiki Kaisha, Osaka-shi, Osaka (JP)

(21) Appl. No.: 13/814,546

(22) PCT Filed: May 18, 2011
(86) PCT No.: PCT/JP2011/061373

§ 371 Date: Feb. 6, 2013

(30) Foreign Application Priority Data
Aug. 9, 2010 (JP) 2010-178481

(51) Int. Cl. G02F 1/1335; F21V 8/00

(52) U.S. Cl. CPC G02F 1/133615; G02B 6/0073
USPC 348/739; 362/612; 349/65

(57) ABSTRACT

Provided is an illuminating device capable of being reduced in thickness. An illuminating device (100) includes a light guide plate (7), a box-shaped chassis (4) arranged to house the light guide plate, light-emitting boards (5) including light-emitting elements (51) on wiring boards (52) and disposed so as to erect in the box-shaped chassis 4, and a frame (11) arranged to cover the chassis. Each of the light-emitting boards has a configuration that the light-emitting elements aligned in a longitudinal direction of each wiring board are unevenly distributed on each wiring board while disposed on an edge portion on a long side of each light-emitting board.

### TECHNICAL FIELD

The present invention relates to an illuminating device, a display device, and a television receiving device including the display device.

### BACKGROUND ART

A transmissive or transflective liquid crystal display device includes a liquid crystal display panel and an illuminating device (a so-called backlight) disposed behind the liquid crystal display panel. In this type of liquid crystal display device, planar light emitted from the illuminating device is used to display an image on a display screen of the liquid crystal display panel.

An edge (side) light type illuminating device is known as the illuminating device, which has a configuration that light-emitting boards such as LED (Light Emitting Diode) boards, which include long wiring boards on which a plurality of LEDs (Light Emitting Diodes) are aligned, are disposed along lateral end faces (light entrance faces) of a light guide plate that defines a clear plate made from an acrylate resin. In this type of illuminating device, the light emitted from the light-emitting boards is guided to enter the light guide plate from the lateral end faces (light entrance faces) of the light guide plate, and thereby the entering light is made into planar light and emitted from a front face (light exit face) of the light guide plate. The light guide plate includes scattering members in a dot pattern that are disposed over a back face or a front face of the light guide plate and arranged to scatter the light that enters from the lateral end faces of the light guide plate. In addition, a reflection sheet arranged to reflect the light is provided on the back face of the light guide plate. Thus, the light emitted from the light-emitting boards as described above is scattered or reflected by the scattering members or the reflection sheet, and is thus made into planar light and emitted from the front face (upper face) of the light guide plate.

For example, PTL 1 discloses this type of edge light type illuminating device.

### CITATION LIST

### Patent Literature

PTL 1: JP 2008-147043

### SUMMARY OF INVENTION

### Technical Problem

FIG. 8 is a cross-sectional view showing a schematic configuration of a conventional liquid crystal display device 1P. The liquid crystal display device 1P mainly includes an edge light type illuminating device 100P, a liquid crystal display panel 2P disposed on the illuminating device 100P, and a bezel (outer frame) 3P having a frame shape and arranged to cover the periphery of the liquid crystal display panel 2P to be fixed to the illuminating device 100P.

The edge light type illuminating device 100P mainly includes a backlight chassis 4P having a box shape (a box-shaped chassis 4P), a reflection sheet 6P laid on a bottom plate 41P of the box-shaped chassis 4P, a light guide plate 7P disposed on the bottom plate 41P on which the reflection sheet 6P is laid, LED boards 5 arranged to project light onto lateral end faces 71P of the light guide plate 7P, optical sheets 8P to 10P disposed on an upper face 72P of the light guide plate 7P, and a frame (inner frame) 11P having a frame shape and arranged to cover the box-shaped chassis 4P.

The LED boards 5P include long wiring boards 52P on which a plurality of LEDs 51P are mounted, and the wiring boards 52P are fixed to wall plates 42P of the box-shaped chassis 4P so as to erect on the bottom plate 41P as shown in FIG. 8. In order to ensure that wiring patterns are provided on the LED boards 5P, the LED boards 5P (the wiring boards 52P) need to have a given width at least. Usually, the wiring boards 52P are larger in width than the LEDs 51p mounted thereon (see FIG. 8).

The liquid crystal display device 1P having the configuration described above has a problem because the liquid crystal display device 1P is structurally difficult to be reduced in thickness (the distance between the bottom plate 41P of the box-shaped chassis 4P and the bezel 3P). This is because the height (width) of the LED boards 5P that are disposed so as to erect in the box-shaped chassis 4P limits downsizing (reducing in thickness) of the liquid crystal display device 1P.

An object of the present invention is to provide an illuminating device, in which the height of light-emitting boards, which are disposed on inner wall faces of a box-shaped chassis and arranged to guide illumination light to enter a light guide plate from lateral end faces of the light guide plate disposed on an inner bottom face of the box-shaped chassis, is reduced as much as possible, and thereby the illuminating device can be reduced in thickness. Another object of the present invention is to provide a display device including the illuminating device. Another object of the present invention is to provide a television receiving device including the display device.

### Solution to Problem

To achieve the objects and in accordance with the purpose of the present invention, an illuminating device of the present invention includes a chassis having a box shape and including a bottom plate and wall plates surrounding the bottom plate, a light guide member disposed on an inner bottom face of the chassis while sandwiching a reflection sheet therebetween and including end faces that define light entrance faces from which light emitted from a light source enters and an upper face that define a light exit face from which planar light is emitted, light-emitting boards, each of which includes a wiring board and a plurality of light-emitting elements mounted on the wiring board while aligned in a longitudinal direction of the wiring board, and which are disposed between the wall plates of the chassis and the light entrance faces of the light guide member while the light-emitting elements face the light entrance faces of the light guide member, and a frame arranged to cover an outer peripheral portion of the light guide member, wherein each light-emitting board has a configuration that the light-emitting elements aligned in the longitudinal direction are unevenly distributed on each wiring board while disposed at positions on an edge side on a long side of each light-emitting board.

It is preferable that the wall plates of the chassis have a height lower than the wiring boards on which the light-emitting elements are disposed.

It is preferable that each light-emitting board has a configuration that the light-emitting elements are unevenly distributed on each wiring board while disposed at positions on a side of each wiring board, the side being opposite to another side of each wiring board that is close to the light exit face of the light guide member.

It is preferable that the bottom plate of the chassis includes holes into which convex portions that are provided at lower ends of the wiring boards are inserted and fitted.

It is preferable that each light-emitting board has a configuration that the light-emitting elements on each wiring board are unevenly distributed on each wiring board while disposed on a side of each wiring board, the side being close to the light exit face of the light guide member.

It is preferable that the light-emitting elements define light emitting diodes.

It is preferable that each of the light emitting diodes includes a blue light-emitting chip that is coated with a fluorescent material that has an emission peak wavelength in a yellow region, and the light emitting diodes are arranged to emit white light.

It is preferable that each of the light emitting diodes includes a blue light-emitting chip that is coated with a fluorescent material that has an emission peak wavelength in a green region and a red region, and the light emitting diodes are arranged to emit white light.

It is preferable that each of the light emitting diodes includes a blue light-emitting chip that is coated with a fluorescent material that has an emission peak wavelength in a green region and a red light-emitting chip, and the light emitting diodes are arranged to emit white light.

It is preferable that each of the light emitting diodes includes a blue light-emitting chip, a green light-emitting chip, and a red light-emitting chip, and the light emitting diodes are arranged to emit white light.

It is preferable that each of the light emitting diodes includes an ultraviolet light chip, and a fluorescent material.

It is preferable that each of the light emitting diodes includes an ultraviolet light chip that is coated with a fluorescent material that has an emission peak wavelength in a blue region, a green region, and a red region, and the light emitting diodes are arranged to emit white light.

In another aspect of the present invention, a display device includes the illuminating device described above, and a display panel arranged to make display by using light emitted from the illuminating device.

It is preferable that the display panel defines a liquid crystal display panel that includes a pair of substrates and liquid crystals filled between the substrates.

Yet, in another aspect of the present invention, a television receiving device includes the display device described above.

### Advantageous Effects of Invention

Having the configuration that the light emitted from the light-emitting elements disposed on the light-emitting boards disposed on the inner wall faces of the box-shaped chassis effectively enters the light guide plate from the lateral end faces of the light guide plate disposed on the inner bottom face of the box-shaped chassis, the illuminating device of the present invention can be reduced in thickness. Thus, the display device including the illuminating device can be reduced in thickness, and the television receiving device including the display device can be reduced in thickness.

### BRIEF DESCRIPTION OF DRAWINGS

FIG. 1 is an exploded perspective view showing a schematic configuration of a liquid crystal display device of a preferred embodiment of the present invention.

FIG. 2 is an explanatory view showing a schematic cross-sectional configuration of the liquid crystal display device shown in FIG. 1.

FIG. 3 is an explanatory (plan) view schematically showing a modification of a light-emitting board of the present invention.

FIG. 4 is an explanatory (plan) view schematically showing a modification of an inner chassis.

FIG. 5 is an exploded perspective view showing a schematic configuration of a television receiving device of a preferred embodiment of the present invention.

FIG. 6 is an explanatory view showing a schematic configuration of a liquid crystal display device of another preferred embodiment of the present invention.

FIG. 7 is an explanatory view showing a schematic configuration of a liquid crystal display device of another preferred embodiment of the present invention.

FIG. 8 is a cross-sectional view showing a schematic configuration of a conventional liquid crystal display device.

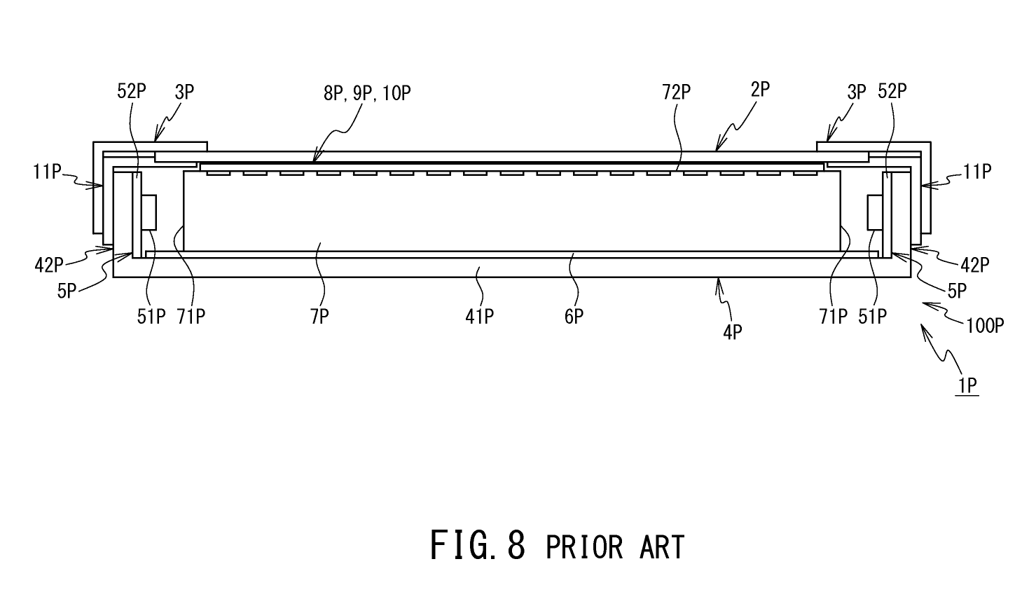

### DESCRIPTION OF EMBODIMENTS

A detailed description of a liquid crystal display device of the present invention will now be provided with reference to the accompanying drawings. The present invention shall not be construed as limited to the preferred embodiments described in the present specification. Components that have the same functions are explained once, providing the same reference numerals to the components in the drawings and the present specification.

[Liquid Crystal Display Device]

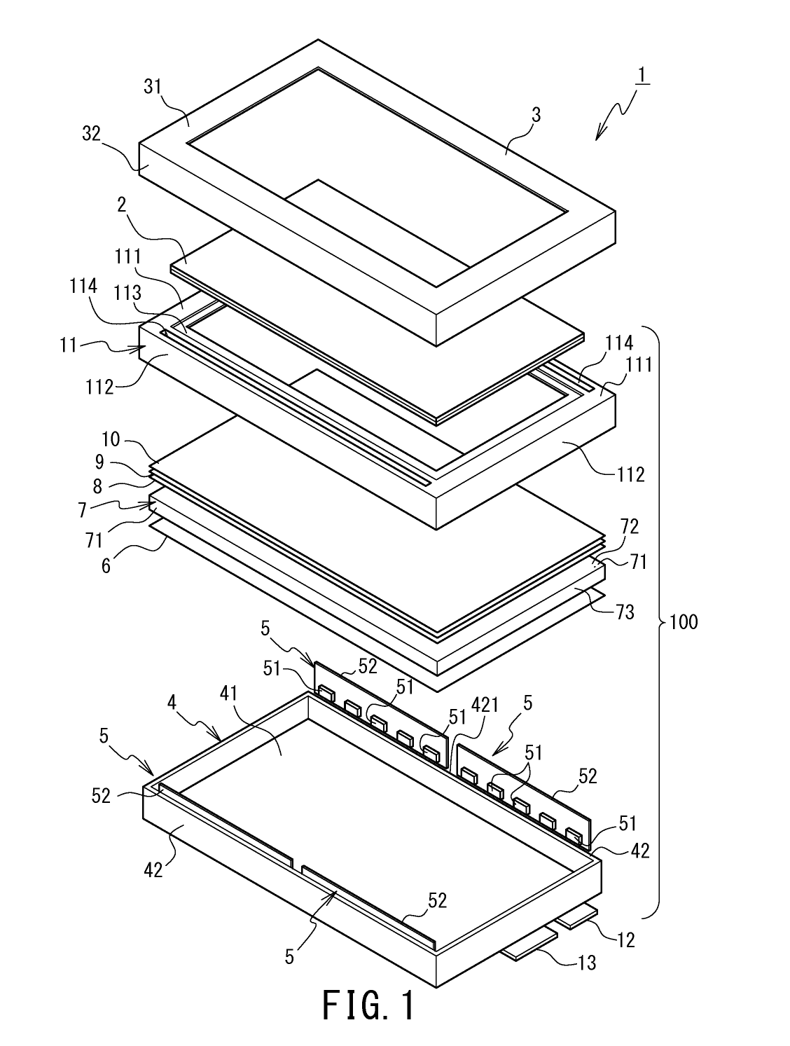

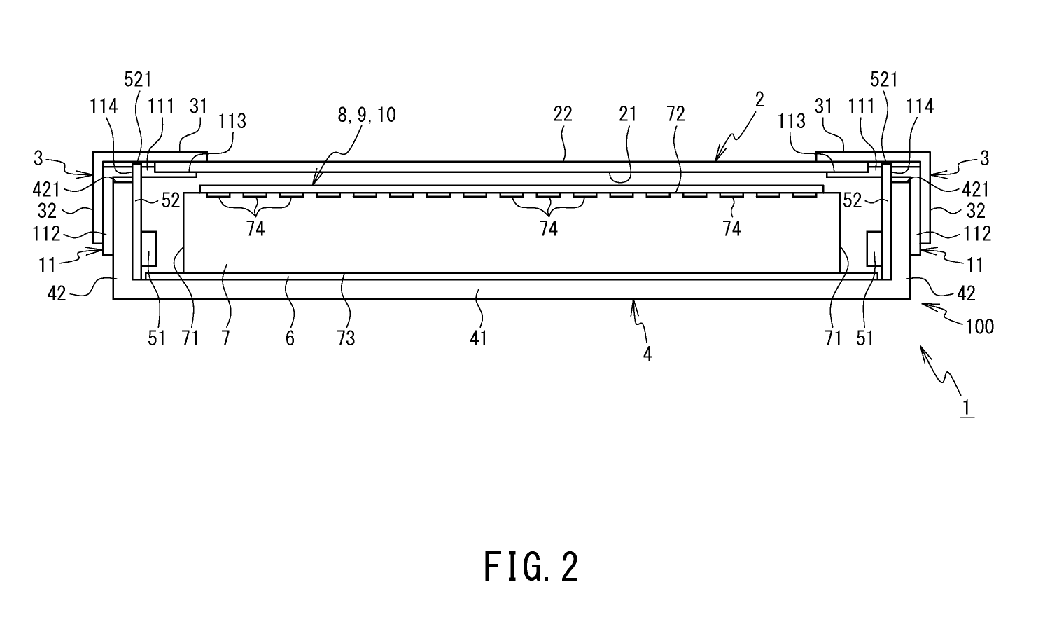

FIG. 1 is an exploded perspective view showing a schematic configuration of a liquid crystal display device 1 of a preferred embodiment of the present invention. FIG. 2 is an explanatory view showing a schematic cross-sectional configuration of the liquid crystal display device 1. The liquid crystal display device 1 includes an edge light type illuminating device 100. The liquid crystal display device 1 includes the edge light type illuminating device 100, a liquid crystal display panel 2, and a bezel (outer frame) 3, which are disposed in this order from the bottom as shown in FIG. 1.

The edge light type illuminating device 100 includes a backlight chassis 4 having a box shape (a box-shaped chassis 4), LED boards (light-emitting boards) 5, a reflection sheet 6, a light guide plate 7, optical sheets 8 to 10, and a frame (inner frame) 11, which are disposed in this order from the bottom as shown in FIG. 1.

The box-shaped chassis 4 preferably defines a box of low height prepared by bending a metal plate made from aluminum. The box-shaped chassis 4 includes a bottom plate 41 having a rectangular shape, and wall plates 42 that erect around the bottom plate 41 as shown in FIGS. 1 and 2. The box-shaped chassis 4 houses the LED boards (light-emitting boards) 5, the reflection sheet 6, the light guide plate 7, and the optical sheets 8 to 10.

The LED boards 5 include wiring boards 52, on each of which a plurality of LEDs (light-emitting elements) 51 are mounted. The wiring boards 52 have a long shape (a long strip-like rectangular shape), and are preferably made of printed boards. The LEDs 51 are electrically connected in series to each other by wiring patterns of each wiring board 52. LED chips themselves, or LED packages that include LED chips are preferably used as the LEDs 51. Each LED package has a configuration such that an LED chip is encapsulated in a transparent resin, and electrodes for sending electricity to the LED chip are mounted on a surface of the resin. Known LED packages arranged to emit white light are used as the present LED packages.

For the LEDs 51, it is preferable to use an LED having a configuration such that a blue light-emitting chip is coated with a fluorescent material that has an emission peak wavelength in a yellow region so as to emit white light, an LED having a configuration such that a blue light-emitting chip is coated with a fluorescent material that has an emission peak wavelength in a green region and a red region so as to emit white light, an LED having a configuration such that a blue light-emitting chip is coated with a fluorescent material that has an emission peak wavelength in a green region and used in combination with a red light-emitting chip so as to emit white light, an LED having a configuration such that a blue light-emitting chip, a green light-emitting chip and a red light-emitting chip are used in combination so as to emit white light, an LED having a configuration such that an ultraviolet light chip is used in combination with a fluorescent material, or an LED having a configuration such that an ultraviolet light chip is coated with a fluorescent material that has an emission peak wavelength in a blue region, a green region and a red region so as to emit white light.

The LED boards 5 are fixed to the wall plates 42 of the box-shaped chassis 4 by fixing means (not illustrated, e.g., screws) so as to erect with respect to the bottom plate 41 of the box-shaped chassis 4, i.e., so that the wiring boards 52 are disposed perpendicular to the bottom plate 41. The LED boards 5 may be fixed directly to the wall plates 42 of the box-shaped chassis 4, or may fixed thereto by additional members. However, when the LED boards 5 are fixed by additional members, it is necessary to determine the height of the additional members so as not to go beyond the front ends of the erecting wiring boards 52.

The LEDs 51 on each LED board are aligned in a length (longitudinal, drawing) direction of each wiring board 52 while spaced apart from each other (e.g., at regular intervals). In addition, the LEDs 51 are unevenly distributed on each wiring board 52 so as to be disposed on a lower end side (on an edge portion on a long side) in a heightwise (width, short) direction of each erecting wiring board 52 as shown in FIG. 1. It is to be noted that in the present specification, the wording “the LEDs 51 are unevenly distributed on each wiring board 52 so as to be disposed on a lower end side” means that light-emitting elements (LEDs) are unevenly distributed on each wiring board so as to be disposed on a lower end side that is lower than a center line that is hypothetically drawn in a length direction of the wiring board. The positions on each wiring board 52 at which the light-emitting elements 51 are disposed are usually determined so that the light emitted from the light-emitting elements 51 effectively enters from lateral end faces 71 of the light guide plate 7. In the present embodiment, having the configuration that the light-emitting elements 51 are disposed on the lower end sides, the wiring boards 52 can secure portions (upper ends 521) that are inserted into holes 114 of the inner frame 11, in a convincing way.

The brightness (luminance) of the LEDs 51 is adjusted to be equal to one another. The LED boards 5 are electrically connected to a power board 12 disposed behind the box-shaped chassis 4. Power is supplied from the power board 12 to the LED boards 5.

In the present embodiment, the LED boards 5 are fixed to the wall plates 42 that correspond to the two long sides of the bottom plate 41 among the wall plates 42 surrounding the bottom plate 41. The LED boards 5 are opposed to each other inside the box-shaped chassis 4. In the present embodiment, two LED boards 5 are fixed side by side to each wall plate 42 as shown in FIG. 1. In the present embodiment, the positions of front ends 421 of the wall plates 42 (the height of the wall plates 42 from the bottom plate 41) are determined to be lower than the positions of the front ends 521 of the erecting wiring boards 52 of the LED boards (light-emitting boards) 5 (the height of the wiring boards 52 from the bottom plate 41). That is, the wiring boards 52 of the LED boards 5 are disposed so as to protrude upward from the inside of the box-shaped chassis 4. In the present embodiment, all the LED boards 5 are equal in height (the wiring boards 52 are equal in width).

The reflection sheet 6 has a rectangular shape, and is laid on the bottom plate 41 of the box-shaped chassis 4. The reflection sheet 6 defines a white expanded resin sheet (e.g., an expanded polyethylene terephthalate sheet). The light guide plate 7 is disposed on the reflection sheet 6.

The light guide plate 7 has a rectangular shape as a whole when seen in a plan view. The light guide plate 7 defines a plate member made from a clear material such as an acrylic resin, which is about 3 to 4 mm in thickness. In the present embodiment, light emitted from the LEDs 51 on the LED boards 5 enters from two end faces (lateral end faces) 71 on the long sides of the light guide plate 7. The end faces 71 define light entrance faces. The LED boards 5 are disposed between the lateral end faces 71 of the light guide plate 7 and the wall plates 42 of the box-shaped chassis 4 as shown in FIG. 2.

The light guide plate 7 includes a plurality of scattering members 74 in a dot pattern that are disposed on a front face (upper face) 72 of the light guide plate 7. The scattering members 74 are preferably provided thereon by dotting paint containing a white pigment on the front face 72 of the light guide plate 7 in a silkscreening printing method, or are preferably provided thereon by forming concave portions (i.e., frosting) on the front face 72 of the light guide plate 7, which are formed by shaving the front face 72. The light guide plate 7 is locked by locking pins (not illustrated) erecting from the bottom plate 41, and is thus positioned with respect to the box-shaped chassis 4. The front face 72 of the light guide plate 7 defines a light exit face.

The optical sheets 8 to 10 are disposed on the front face 72 of the light guide plate 7. The optical sheets 8 to 10 define resin sheets, each of which has a rectangular shape, and is about 0.1 to 0.5 mm in thickness. The optical sheets 8 to 10 are stacked on the front face 72 of the light guide plate 7.

The optical sheet 8 defines a so-called diffusion sheet, and is arranged to diffuse the light emitted from the front face 72 of the light guide plate 7 to allow uniformalization of luminance distribution of the light. The optical sheet 9 defines a so-called lens sheet, and is arranged to gather the light emitted from the diffusion sheet (optical sheet 8) to allow enhancement of front brightness of the light. The optical sheet 10 defines a so-called polarization selective reflection sheet, and is arranged to selectively reflect the light emitted from the lens sheet (optical sheet 9) so that the light is not absorbed by a polarizing plate (not illustrated) that is attached on the lower side of the liquid crystal display panel 2.

The inner frame 11 includes an eaves plate (inner eaves plate) 111 having a frame shape that is arranged to cover the upper (front) ends 421 of the wall plates 42, and peripheral walls (inner peripheral walls) 112 extending downward from the eaves plate 111 so as to cover the outer faces of the wall plates 42. The inner frame 11 is arranged to cover the box-shaped chassis 4 that houses the stack of the reflection sheet 6, the light guide plate 7 and the optical sheets 8 to 10. The inner frame 11 is prepared, for example, by processing a known material such as a metallic or a plastic material so as to have a predetermined shape.

A positioning member 113 having a concave frame shape is provided around the upper inner periphery of the eaves plate 111. The liquid crystal display panel 2 is disposed on the inner frame 11 so as to be fitted into the positioning member 113.

The eaves plate 111 includes holes 114 disposed outer than the position where the periphery of the liquid crystal display panel 2 is disposed. The front (upper) ends 521 of the wiring boards 52 of the LED boards 5 are inserted into the holes 114. The holes 114 have a shape such that the front ends of the wiring boards 52 are fitted therein. Each hole 114 of the eaves plate 111 has the shape of a long thin flute as shown in FIG. 1.

The peripheral walls 112 surround the wall plates 42 so as to be in close contact with the outer faces of the wall plates 42. The peripheral walls 112 are fixed to the wall plates 42 while the inner frame 11 covers the box-shaped chassis 4. The positions of the lower ends of the peripheral walls 112 are determined as appropriate. For example, it is preferable that the positions of the lower ends of the peripheral walls 112 do not go beyond the position of the bottom plate 41 from the viewpoint of downsizing of the liquid crystal display device 1.

Either will do, whether the lower (back) face of the eaves plate 111 is in contact with the front ends 421 of the wall plates 42, or not. However, it is preferable that the inner frame 11 covers the box-shaped chassis 4 such that the lower (back) face of the eaves plate 111 is in close contact with the front ends 421 of the wall plates 42 from the viewpoint of downsizing of the liquid crystal display device 1.

The liquid crystal display panel 2 is disposed to cover the light guide plate 7 while the periphery of the liquid crystal display panel 2 is disposed on the upper side of the inner frame 11 as shown in FIG. 2. The liquid crystal display panel 2 consists of two glass substrates that are bonded together while sandwiching a liquid crystal material therebetween. One of the glass substrates defines a TFT (Thin Film Transistor) substrate and the other defines a CF (Color Filter) substrate. The liquid crystal material is filled between these substrates. The liquid crystal display panel 2 is arranged to receive light that is projected onto its back face 21 from the illuminating device 100, and display an image on its front face 22 using the light. The liquid crystal display panel 2 is electrically connected to and driven by a control circuit board 13 that is disposed behind the illuminating device 1 (see FIG. 1).

The outer frame (bezel) 3 includes an eaves plate (outer eaves plate) 31 having a frame shape, and peripheral walls (outer peripheral walls) 32 extending downward from the eaves plate 31. The outer frame 3 is arranged to cover the inner frame 11 on which the liquid crystal display panel 2 is disposed. The eaves plate 31 is disposed so as to cover the periphery of the liquid crystal display panel 2 that is disposed on the upper side of the eaves plate (inner eaves plate) 111. The periphery of the liquid crystal display panel 2 is sandwiched and held between the eaves plate 31 and the eaves plate 111 of the inner frame 11. The peripheral walls 32 surround the peripheral walls 112 of the inner frame 11 so as to be in close contact therewith.

The peripheral walls 32 are fixed to the peripheral walls 112 of the inner frame 11 and the wall plates 42 of the box-shaped chassis 4 while the outer frame 3 covers the inner frame 11 and the periphery of the liquid crystal display panel 2. Being fixed to the box-shaped (backlight) chassis 4, the outer frame (bezel) 3, together with the box-shaped chassis 4, is arranged to ensure strength of the entire liquid crystal display device 1.

In the present embodiment, the positions of the lower ends of the peripheral walls 32 are determined so as not go beyond the positions of the lower ends of the peripheral walls 112. In other embodiments, the positions of the lower ends of the peripheral walls 32 may go beyond the positions of the lower ends of the peripheral walls 112. It is preferable that the positions of the lower ends of the peripheral walls 32 do not go beyond the position of the bottom plate 42 of the box-shaped chassis 4 from the viewpoint of downsizing of the liquid crystal display device 1. The outer frame 3 is prepared, for example, by processing a known material such as a metallic or a plastic material so as to have a predetermined shape.

Hereinafter, the reason why downsizing of the liquid crystal display device 1 of the present embodiment is possible will be provided with reference to FIG. 2. The liquid crystal display device 1 has the configuration that the LED boards 5 are fixed in the boxed-shaped chassis 4 while erecting with respect to the bottom plate 41, while the top (upper) ends 521 of the wiring boards 52 protrude more upward than the front ends 421 of the wall plates 42 as shown in FIG. 2. The protruding portions (i.e., the front ends 521 of the wiring boards 52) are inserted into the holes 114 of the eaves plate 111 of the inner frame 11 that covers the box-shaped chassis 4. The front ends 521 of the wiring boards 52 pass through the holes 114 of the eaves plate 111 to protrude more upward than the eaves plate 111. There are clearances (spaces) between the inner frame 11 and the outer frame 3, and the front ends 521 of the wiring boards 52 are disposed in the clearances.

Thus, having the configuration that the inner frame 11 covers the box-shaped chassis 4 while the height of the wall plates 42 is made lower than the height of the wiring boards 52 and the holes 114 into which the front (upper) ends 521 of the wiring boards 52 are inserted are provided to the eaves plate 111 of the inner frame 11, the liquid crystal display device 1 can be reduced in thickness (i.e., the distance between the bottom plate 41 and the outer frame 3 can be reduced) by just as much as the reduced height of the wall plates 42. The liquid crystal display device 1 having the configuration described above can be favorably downsized (reduced in thickness) when downsizing of the light-emitting boards (LED boards) 5 is limited (i.e., when the wiring boards 52 cannot be reduced in width).

In the liquid crystal display device 1 of the present embodiment, the light guide plate 7 can be reduced in thickness, too. When the light guide plate 7 can be reduced in thickness, the light that enters from the lateral end faces 71 can be reflected many times between the upper (front) face 72 and the lower (back) face 73 of the light guide plate 7, which allows the planar light to be more uniformly emitted from the upper face 72 of the light guide plate 7.

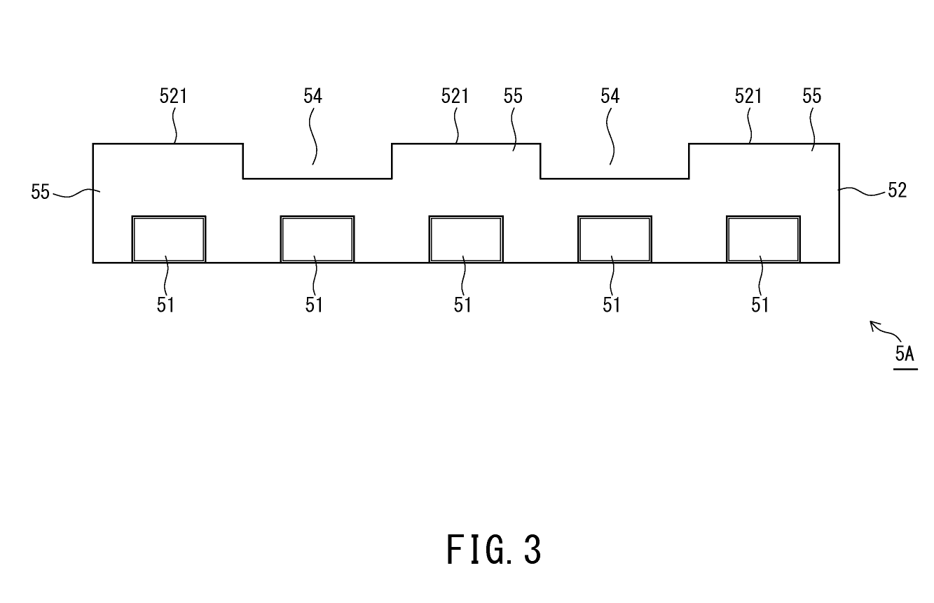

FIG. 3 is an explanatory (plan) view schematically showing a modification of a light-emitting board. Each light-emitting board 5A defines an LED board, and has a configuration such that a plurality of LEDs (light-emitting elements) 51 are mounted on each wiring board 52 similarly to the LED boards 5 shown in FIG. 1. The LEDs 51 are unevenly distributed on each wiring board 52 so as to be disposed on one end side in a width (short) direction of each wiring board 52. Meanwhile, a plurality of (two) concave portions 54 and a plurality of (three) convex portions 55 are provided alternately on the other end side of each wiring board 52. The light-emitting boards 5A that include the wiring boards 52 having this configuration are preferably used in the liquid crystal display device 1 as they are. In this case, the convex portions 55 of the light-emitting boards 5A are inserted into the holes 114 of the inner frame 11 in the liquid crystal display device 1. End portions of the convex portions 55 are regarded as front (upper) ends 521 of the wiring boards 52. That is, the positions of front ends 421 of the wall plates 42 of the box-shaped chassis 4 are determined to be lower than the positions of the front (upper) ends 521 of the convex portions 55.

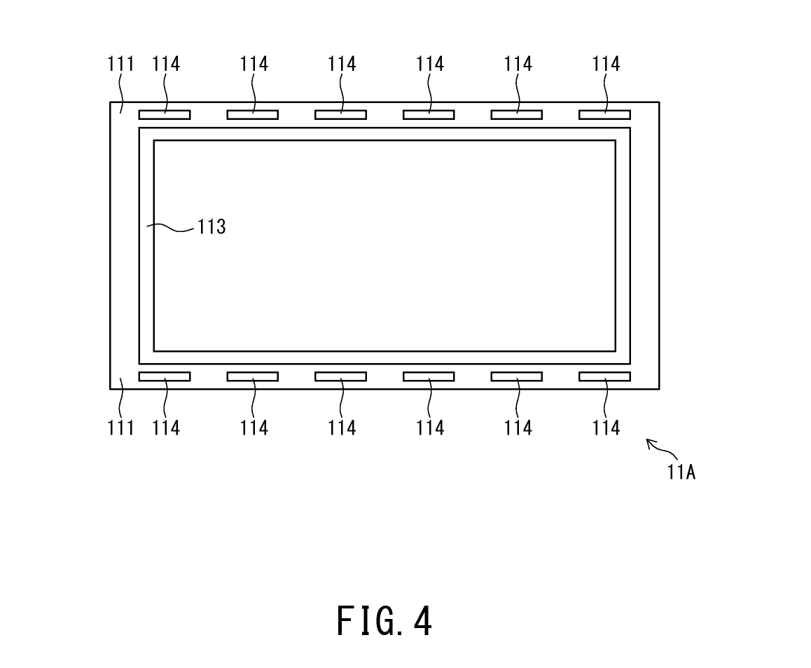

FIG. 4 is an explanatory (plan) view schematically showing a modification of an inner chassis. The basic configuration of an inner chassis 11A shown in FIG. 4 is similar to that of the inner frame 11 shown in FIG. 1; however, the inner chassis 11A includes a plurality of holes 114 on an eaves plate 111. The holes 114 have a configuration such that when the light-emitting boards 5A shown in FIG. 3 are used, the front ends 521 of the convex portions 55 are each inserted into the holes 114. As described above, the shape and the number of the holes of the inner chassis may be changed as appropriate so as to correspond to the shape of the front ends of the light-emitting boards 5.

While, in the liquid crystal display device 1 shown in FIGS. 1 and 2, the holes 114 provided to the inner frame 11 may be through-holes, the holes 114 may also be dents that are made by shaving the lower face of the eaves plate 111 if the objects in accordance with the purpose of the present invention can be achieved. However, it is preferable that the holes 114 define through-holes from the viewpoint of reduction in thickness of the liquid crystal display device 1.

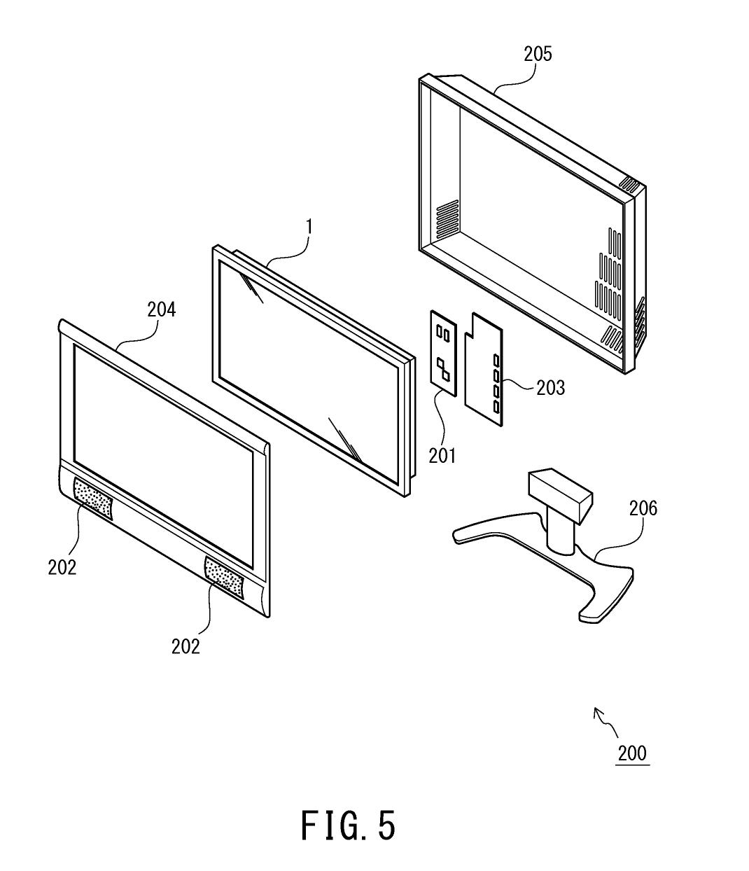

The liquid crystal display device 1 of the present embodiment is used preferably in a television receiving device. A description of a television receiving device of a preferred embodiment of the present invention will be provided with reference to FIG. 5. FIG. 5 is an exploded perspective view showing a schematic configuration of the television receiving device of the present embodiment. A television receiving device 200 includes the liquid crystal display device 1, a tuner 201, loudspeaker units 202, an electric power supply 203, a front side cabinet 204, a back side cabinet 205, and a supporting member 206.

The tuner 201 is arranged to produce an image signal and a sound signal of a given channel based on a received radio wave. A conventional terrestrial tuner (analog and/or digital), a BS tuner and a CS tuner are preferably used as the tuner 201.

The loudspeaker units 202 are arranged to produce a sound based on the sound signal produced by the tuner 201. Generally-used speakers are preferably used as the loudspeaker units 202.

The electric power supply 203 is arranged to supply electric power to the liquid crystal display device 1, the tuner 201, the loudspeaker units 202 and other components.

The liquid crystal display device 1, the tuner 201, the loudspeaker units 202 and the electric power supply 203 are sandwiched between the front side cabinet 204 and the back side cabinet 205, and housed therein, which are supported by the supporting member (i.e., stand) 206.

Including liquid crystal display device 1, the television receiving device 200 of the present embodiment can be downsized (reduced in thickness).

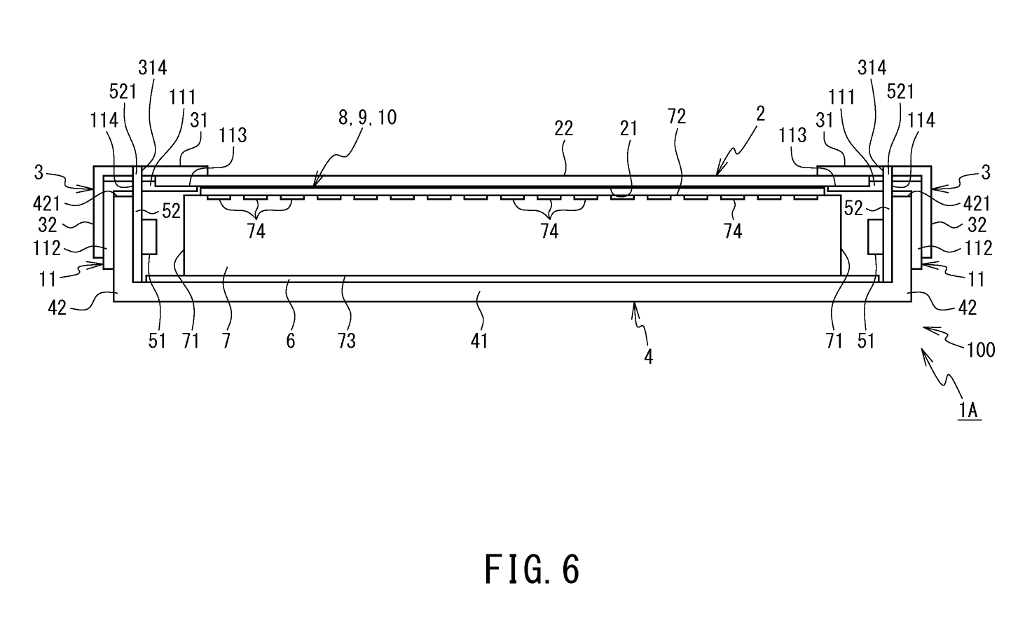

A description of a liquid crystal display device of another embodiment of the present invention will be provided with reference to FIG. 6. FIG. 6 is an explanatory view showing a schematic configuration of a liquid crystal display device 1A of the present embodiment. The basic configuration of the liquid crystal display device 1A is similar to that of the liquid crystal display device 1 shown in FIGS. 1 and 2; however, the liquid crystal display device 1A can be reduced in thickness more than the liquid crystal display device 1 shown in FIG. 1. The outer frame (bezel) 3 of the liquid crystal display device 1A includes holes 314 into which the front (upper) ends 521 of the erecting wiring boards 52 are inserted. That is, the front (upper) ends 521 of the erecting wiring boards 52 are inserted not only into the holes 114 of the inner frame 11 but also into the holes 314 of the outer frame 3. In this embodiment, the positions of the front ends 421 of the wall plates 42 of the box-shaped chassis 4 can be determined to be lower than those of the liquid crystal display device 1 shown in FIG. 2. Having this configuration, the liquid crystal display device 1A can be reduced in thickness more than the liquid crystal display device 1. The holes 314 provided to the outer frame 3 may also be dents that are made by shaving the lower face of the eaves plate 31 so that the dents may not pass through the eaves plate 31.

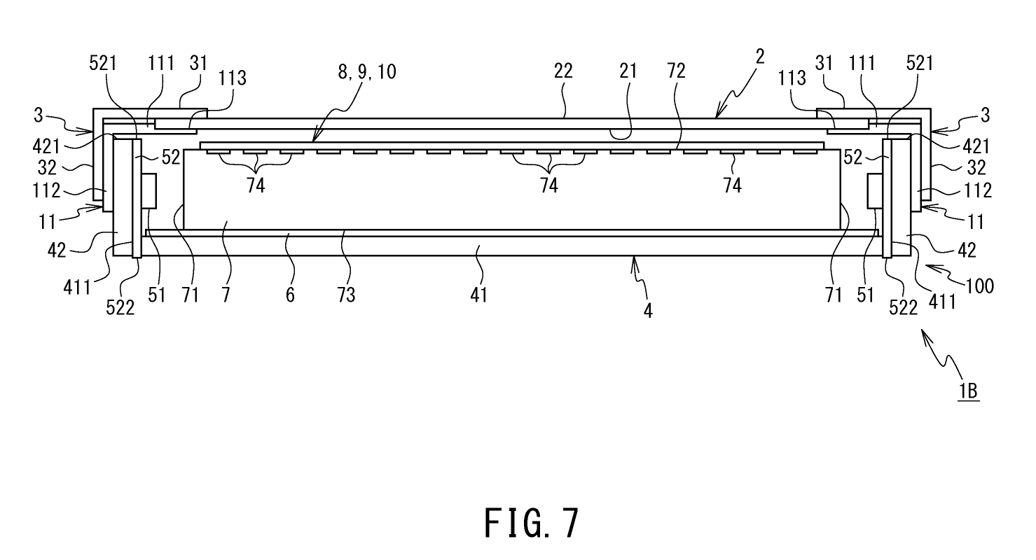

A description of a liquid crystal display device of another embodiment of the present invention will be provided with reference to FIG. 7. FIG. 7 is an explanatory view showing a schematic configuration of a liquid crystal display device 1B of the present embodiment. Unlike the other embodiments, the eaves plate 111 of the inner frame 11 of the liquid crystal display device 1B of the present embodiment includes no hole into which the front ends of the wiring boards 52 are to be inserted. However, the bottom plate 41 of the box-shaped chassis 4 of the liquid crystal display device 1B includes holes 411 into which lower ends 522 of the wiring boards 52 are inserted. That is, the light-emitting boards 5 are housed in the box-shaped chassis 4 so as to partially protrude from the bottom plate 41. Thus, the height of the wiring boards 52 from the bottom plate 41 (the distance between the bottom plate 41 and the front ends 521) can be determined to be lower than that of wiring boards used in a conventional liquid crystal display device. In addition, the height of the wall plates 42 of the box-shaped chassis 4 (the distance between the bottom plate 41 and the front ends 421) can be determined to be lower than that of wall plates used in a conventional liquid crystal display device. In the present embodiment, the front ends 521 of the wiring boards 52 and the front ends 421 of the wall plates 42 are determined to be equal to each other. The positions of the front ends 421 of the wall plates 42 are determined so as not to go beyond the height of the front ends 521 of the wiring boards 52 from the viewpoint of downsizing of the liquid crystal display device 1B.

Thus, having the configuration that the lower ends 522 of the wiring boards 52 protrude through the holes 411 of the bottom plate 41, the liquid crystal display device 1B can be reduced in thickness (i.e., the distance between the bottom plate 41 and the outer frame 11 can be reduced) because the height of the wiring boards 52 in the box-shaped chassis 4 can be made lower, and accordingly the height of the wall plates 42 can be made lower.

For example, light-emitting boards 5 having a configuration such that light-emitting elements (LEDs) 51 are unevenly distributed on each erecting wiring board 52 so as to be disposed on an upper end side (on an edge portion on a long side) in a heightwise (width, short) direction of each erecting wiring board 52 are used for the light-emitting boards 5 of the liquid crystal display device 1B. It is to be noted that in the present specification, the wording “light-emitting elements (LEDs) 51 are unevenly distributed on each erecting wiring board 52 so as to be disposed on an upper end side” means that light-emitting elements (LEDs) are unevenly distributed on each wiring board so as to be disposed on an upper end side that is upper than a center line that is hypothetically drawn in a length direction of the wiring board. The positions on each wiring board 52 at which the light-emitting elements 51 are disposed are usually determined so that the light emitted from the light-emitting elements 51 effectively enters from the lateral end faces 71 of the light guide plate 7. In the present embodiment, having the configuration that the light-emitting elements 51 are disposed on the sides close to the front ends 521, the wiring boards 52 can secure portions (the lower ends 522) that are inserted into the holes 411 of the bottom plate 41, in a convincing way.

1. An illuminating device comprising:
a chassis having a box shape, the chassis comprising:
a bottom plate; and
wall plates surrounding the bottom plate;
a light guide member disposed on an inner bottom face of the chassis while sandwiching a reflection sheet therebetween, the light guide member comprising;
end faces that comprise light entrance faces from which light emitted from a light source enters; and
an upper face that comprises a light exit face from which planar light is emitted;
light-emitting boards, each of which comprises:
a wiring board; and
a plurality of light-emitting elements mounted on the wiring board while aligned in a longitudinal direction of the wiring board, the light-emitting boards being disposed between the wall plates of the chassis and the light entrance faces of the light guide member while the light-emitting elements face the light entrance faces of the light guide member; and
a frame arranged to cover an outer peripheral portion of the light guide member, wherein each light-emitting board has a configuration that the light-emitting elements aligned in the longitudinal direction are unevenly distributed on each wiring board while disposed at positions on an edge side on a long side of each light-emitting board.

2. The illuminating device according to claim 1, wherein the wall plates of the chassis have a height lower than the wiring boards on which the light-emitting elements are disposed.

3. The illuminating device according to claim 1, wherein each light-emitting board has a configuration that the light-emitting elements are unevenly distributed on each wiring board while disposed at positions on a side of each wiring board, the side being opposite to another side of each wiring board that is close to the light exit face of the light guide member.

4. The illuminating device according to claim 1, wherein the bottom plate of the chassis comprises holes into which convex portions that are provided at lower ends of the wiring boards are inserted and fitted.

5. The illuminating device according to claim 4, wherein each light-emitting board has a configuration that the light-emitting elements on each wiring board are unevenly distributed on each wiring board while disposed on a side of each wiring board, the side being close to the light exit face of the light guide member.

6. The illuminating device according to claim 1, wherein the light-emitting elements comprise light emitting diodes.

7. The illuminating device according to claim 6, wherein each of the light emitting diodes comprises a blue light-emitting chip that is coated with a fluorescent material that has an emission peak wavelength in a yellow region, and the light emitting diodes are arranged to emit white light.

8. The illuminating device according to claim 6, wherein each of the light emitting diodes comprises a blue light-emitting chip that is coated with a fluorescent material that has an emission peak wavelength in a green region and a red region, and the light emitting diodes are arranged to emit white light.

9. The illuminating device according to claim 6, wherein each of the light emitting diodes comprises:
a blue light-emitting chip that is coated with a fluorescent material that has an emission peak wavelength in a green region; and
a red light-emitting chip, and the light emitting diodes are arranged to emit white light.

10. The illuminating device according to claim 6, wherein each of the light emitting diodes comprises a blue light-emitting chip, a green light-emitting chip, and a red light-emitting chip, and the light emitting diodes are arranged to emit white light.

11. The illuminating device according to claim 6, wherein each of the light emitting diodes comprises an ultraviolet light chip, and a fluorescent material.

12. The illuminating device according to claim 6, wherein each of the light emitting diodes comprises an ultraviolet light chip that is coated with a fluorescent material that has an emission peak wavelength in a blue region, a green region, and a red region, and the light emitting diodes are arranged to emit white light.

13. A display device comprising:
the illuminating device according to claim 1; and
a display panel arranged to make display by using light emitted from the illuminating device.

14. The display device according to claim 13, wherein the display panel comprises a liquid crystal display panel that comprises a pair of substrates, and liquid crystals filled between the substrates.

15. A television receiving device that comprises the display device according to claim 13.
